(19) United States
(12) Patent Application Publication
(10) Pub. No.: US 2014/0266693 A1
(43) Pub. Date: Sep. 18, 2014

(54) MONITORING A PERSON

(71) Applicant: UNIVERSITY OF TECHNOLOGY, SYDNEY, Ultimo, New South Wales (AU)

(72) Inventor: Bruce David Moulton, New South Wales (AU)

(21) Appl. No.: 13/261,871

(22) PCT Filed: Nov. 14, 2012
(86) PCT No.: PCT/AU2012/001410

§ 371 Date: May 14, 2014

(30) Foreign Application Priority Data
Nov. 14, 2011 (AU) 2011904740

(51) Int. Cl. G08B 21/02

(52) U.S. Cl. CPC G08B 21/02
USPC 340/539.12

(57) ABSTRACT

A system (10), method (200), monitoring device (120), monitoring system (100), sensor device (110), kit, apparatus (105), and/or computer program product for monitoring a person (1000) in an area (2000) is disclosed. In one aspect the monitoring system (100) includes a sensor device (110), mounted in an area (2000), for sensing a person in the area (2000); a monitoring device (120), in communication with the sensor device (110), for: receiving data indicative of one or more sensor signals from the sensor device (110); monitoring the sensor signals to determine if one or more rules are satisfied; and in the event that one or more of the rules are satisfied, communicating with one or more devices to request assistance for the person.

### CROSS-REFERENCE TO RELATED APPLICATIONS

The current application claims priority from Australian Provisional Patent Application 2011904740, the content of which is incorporated herein by reference.

### TECHNICAL FIELD

The present invention relates to a system, method, monitoring device, monitoring system, sensor device, kit, apparatus, and/or computer program product for monitoring a person in an area.

### BACKGROUND

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

There are a number of monitoring systems used which attempt to detect whether a person, in an area, requires assistance. For example, there are a number of systems that attempt to detect if a person has suffered a fall, or has suffered some condition, which requires assistance. These types of systems are most prevalent with the elderly or people who suffer from debilitating conditions.

Known systems have utilised a device which is worn by the monitored person, wherein the device includes some form of sensor to sense particular movements by the person. The sensor can be in the form of an accelerometer which senses the acceleration which the monitored person undergoes. The disadvantage of such systems is that it requires the monitored person to constantly wear the device. In the event that the monitored person removes the device, such as when showering, the device cannot sense if the person requires assistance. In other situations, the monitored person may forget to reapply the device, or may simply dislike wearing the device. As such, these types of devices have numerous drawbacks.

### SUMMARY

In a first aspect there is provided a monitoring system including:
a sensor device, mounted in an area, for sensing a person in the area; and
a monitoring device, in communication with the sensor device, for:
   receiving data indicative of one or more sensor signals from the sensor device;
   monitoring the sensor signals to determine if one or more rules are satisfied; and
   in the event that one or more of the rules are satisfied, communicating with one or more devices to request assistance for the person.

In certain embodiments, the sensor device senses motion of the person in the area.

In certain embodiments, the one or more rules use a presence or lack of motion sensed to determine if the person requires assistance.

In certain embodiments, the sensor device senses one or more distances between the person and the sensor device.

In certain embodiments, the one or more rules use the one or more distances sensed to determine if the person requires assistance.

In certain embodiments, the monitoring device uses the one or more distances sensed to determine one or more derived parameters, the one or more derived parameters include at least one of:
a presence of the person;
a position of the person;
a trajectory of movement of the person;
a velocity of the person; and
an acceleration of the person;
   wherein the one or more rules use the one or more derived parameters in order to determine if the person requires assistance.

In certain embodiments, the sensor device includes:
a motion sensing device for sensing motion of the person; and
a distance sensing device for sensing a distance of the person relative to the sensor device.

In certain embodiments, the sensor device operates in:
a first state wherein the motion sensing device is active and the distance sensing device is inactive; and
a second state wherein the distance sensing device is active in response to the motion sensing device sensing the motion of the person in the first state.

In certain embodiments, the sensor device switches from operating in the second state to the first state in the event that the motion sensing device fails to sense motion for a threshold period of time whilst the sensor device operates in the second state.

In certain embodiments, the motion sensing device is one or more passive infrared sensors.

In certain embodiments, the distance sensing device is at least one of:
one or more ultrasonic sensors;
one or more rangefinder sensors;
one or more depth sensors;
one or more 3D sensors
one or more 3D scanners; and
one or more image sensors.

In certain embodiments, the sensor device includes a communication device for wirelessly communicating with the monitoring device.

In certain embodiments, the monitoring device determines, based on RSSI (received signal strength indicator), a communication frequency for use in wireless communication with the sensor device, wherein the determined communication frequency is transferred to the sensor device for use in wireless communication.

In certain embodiments, the sensor device includes a body including a coupling arrangement for coupling the sensor device to a fixture of an electrical light.

In certain embodiments, the body includes an electrical connector which is in electrical communication with an electrical socket of the fixture, wherein electrical power provided to the electrical light is at least partially used to electrical power to the sensor device.

In certain embodiments, an electrical light is able to be coupled to sensor device via the coupling arrangement, and wherein the electrical light is in electrical communication with the electrical connector.

In certain embodiments, the sensor device is a standalone, battery operated device.

In certain embodiments, the sensor device includes a lighting device.

In certain embodiments, the monitoring system includes a photosensor for sensing ambient light, wherein the lighting device is activated in response to the sensed ambient light being equal or less than a threshold.

In certain embodiments, the sensor device includes a microphone for capturing audio signals which are transferred to the monitoring device and forwarded to one or more devices when assistance is required.

In certain embodiments, the sensor device includes a speaker.

In certain embodiments, sensor device includes a thermal sensor, wherein the data is received by the monitoring device from the sensor device is indicative of one or more signals generated by the thermal sensor, wherein the monitoring device uses the one or more signals generated by the thermal sensor to determine if the person requires assistance.

In certain embodiments, the sensor device is part of or includes at least one of:
a smoke sensor; and
a gas sensor.

In certain embodiments, the one or more rules monitored by the monitoring device are configurable.

In certain embodiments, the monitoring device is in data communication with a server processing system hosting a portal, wherein the one or more rules are configurable via input provided via the portal, wherein configuration data is received by the monitoring device from the server processing system to configure the one or more rules.

In certain embodiments, the monitoring system includes a plurality of sensor devices, wherein the one or more rules are configured to use a distance defined between at least some of the plurality of sensor devices to determine if assistance is required for the person.

In certain embodiments, the monitoring system determines at least one of:
if the person has fallen;
if the person, is incapacitated for a period of time;
if the person is suffering from impairment; and
if there is an increased risk of harm for the person.

In a second aspect there is provided a system including:
a monitoring device according to the first aspect; and
a server processing system in data communication with the monitoring device, wherein the server processing system receives data from the monitoring device.

In certain embodiments, the server processing system has stored in a data store historical data, wherein the server is configured to use the historical data to determine if the person is suffering from or there is an increased risk of harm for the person.

In certain embodiments, the server processing system uses the historical data to determine at least one of:
a decrease in an average travel speed of the person over time indicative of impairment or an increased risk of harm to the person; and
a pattern of movement of the person over time indicative of impairment or an increased risk of harm to the person.

In certain embodiments, the server processing system hosts a portal to allow user input to configure the one or more rules monitored by the monitoring device, wherein configuration data based on the received input from the user is transferred to the monitoring system for configuring the monitoring system.

In certain embodiments, the system includes a plurality of sensor devices, wherein the one or more rules are configured to use a distance defined between at least some of the plurality of sensor devices to determine if assistance is required for the person.

In a third aspect there is provided a sensor device for a monitoring system, the sensor device including:
a mounting to allow the sensor device to be mounted in an area;
one or more sensors for sensing one or more parameters of a person in the area; and
a communication device for transferring, to a monitoring device, data indicative of one or more sensor signals.

In certain embodiments, the sensor device senses motion of the person in the area.

In certain embodiments, the sensor device senses one or more distances to the person relative to the sensor device.

In certain embodiments, the sensor device includes:
a motion sensing device for sensing motion of the person; and
a distance sensing device for sensing a distance of the person relative to the sensor device.

In certain embodiments, the sensor device operates in:
a first state wherein the motion sensing device is active and the distance sensing device is inactive; and
a second state wherein the distance sensing device is active in response to the motion sensing device sensing the motion of the person in the first state.

In certain embodiments, the sensor device switches from operating in the second state to the first state in the event that the motion sensing device fails to sense motion for a threshold period of time whilst the sensor device operates in the second state.

In certain embodiments, the motion sensing device is one or more passive infrared sensors.

In certain embodiments, the distance sensing device is at least one of:
one or more ultrasonic sensors;
one or more rangefinder sensors;
one or more depth sensors;
one or more 3D sensors;
one or more 3D scanners; and
one or more image sensors.

In certain embodiments, the communication device wirelessly communicates with the monitoring device.

In certain embodiments, the sensor device includes a body including a coupling arrangement for coupling the sensor device to a fixture of an electrical light.

In certain embodiments, the body includes an electrical connector which is in electrical communication with an electrical socket of the fixture, wherein electrical power provided to the electrical light is at least partially used to electrical power to the sensor device.

In certain embodiments, an electrical light is able to be coupled to sensor device via the coupling arrangement, and wherein the electrical light is in electrical communication with the electrical connector.

In certain embodiments, the sensor device is a standalone, battery operated device.

In certain embodiments, the sensor device includes a lighting device.

In certain embodiments, the monitoring system includes a photosensor for sensing ambient light, wherein the lighting device is activated in response to the sensed ambient light being equal or less than a threshold.

In certain embodiments, the sensor device includes a microphone for capturing audio signals which are transferred to the monitoring device and forwarded to one or more devices when assistance is required.

In certain embodiments, the sensor device includes a thermal sensor, wherein the data is transferred to the monitoring device is indicative of one or more signals generated by the thermal sensor.

In certain embodiments, the sensor device is part of or includes at least one of:
a smoke sensor; and
a gas sensor.

In a fourth aspect there is provided a monitoring device for monitoring whether a person in an area requires assistance, wherein the monitoring device includes a processing system configured to:
receive, from a sensor device mounted in the area, data indicative of one or more sensor signals;
monitor the sensor signals received from the sensor device to determine if one or more rules stored in memory are satisfied; and
in the event that one or more of the rules are satisfied, communicate with one or more devices to request assistance for the person.

In certain embodiments, the data received from the sensor device is indicative of motion of the person in the area, wherein the one or more rules monitored by the processing system use a presence or lack of motion sensed to determine if the person requires assistance.

In certain embodiments, the data received from the sensor device is indicative of one or more distances to the person relative to the sensor device, wherein the one or more rules monitored by the processing system use the one or more distances sensed to determine if the person requires assistance.

In certain embodiments, the one or more rules use a change in distances sensed over time to determine if the person requires assistance.

In certain embodiments, the monitoring device includes a communication device to wirelessly communicate with the sensor device.

In certain embodiments, the monitoring device determines, based on RSSI (received signal strength indicator), a communication frequency for use in wireless communication with the sensor device, wherein the determined communication frequency is transferred to the sensor device for use in wireless communication between the monitoring device and the sensor device.

In certain embodiments, the sensor device includes a thermal sensor, wherein the data received by from the sensor device is indicative of one or more signals generated by the thermal sensor, wherein the monitoring device uses the one or more signals generated by the thermal sensor to determine if the person requires assistance.

In certain embodiments, one or more rules monitored by the monitoring device are configurable.

In certain embodiments, the monitoring device receives configuration data from a server processing system to configure the one or more rules.

In certain embodiments, the monitoring device is in communication with a plurality of sensor devices mounted in the area, wherein the one or more rules are configured to use a distance defined between at least some of the plurality of sensor devices to determine if assistance is required for the person.

In certain embodiments, the monitoring device determines at least one of:
if the person has fallen;
if the person is incapacitated for a period of time;
if the person is suffering from or has an increased risk of impairment; and
if there is an increased risk of harm for the person.

In a fifth aspect there is provided a kit including:
a sensor device according to the third aspect; and
a monitoring device according to the fourth aspect.

In a sixth aspect there is provided a method of monitoring a person in an area including:
sensing, using a sensor device mounted in an area, one or more parameters of a person in the area;
monitoring, using a monitoring device in communication with the sensor, data indicative of sensor signals, received from the sensor device, to determine if one or more rules are satisfied; and
in the event that one or more of the rules are satisfied, communicating with one or more devices to request assistance for the person.

In a seventh aspect there is provided a method of monitoring a person in an area using a monitoring device, including:
receiving in the monitoring device, from a sensor device mounted in an area, data indicative of one or more sensor signals;
monitoring, in the monitoring device, the sensor signals received from the sensor device, to determine if one or more rules are satisfied; and
in the event that one or more of the rules are satisfied, communicating with one or more devices to request assistance for the person.

In an eighth aspect there is provided a computer program product for configuring a monitoring device including a processing system to monitor a person in an area, wherein the computer program product configures the processing system to:
receive in the monitoring device, from a sensor device mounted in an area, data indicative of one or more sensor signals;
monitor, in the monitoring device, the sensor signals received from the sensor device, to determine if one or more rules are satisfied; and
in the event that one or more of the rules are satisfied, communicate with one or more devices to request assistance for the person.

In a ninth aspect there is provided an apparatus for monitoring a person in an area, including:
a mountable body for mounting the apparatus to the area;
a sensor device at least partially housed by the body for sensing one or more parameters of a person in the area; and
a monitoring device, in communication with the sensor device and at least partially housed by the body, for monitoring sensor signals indicative of the one or more parameters to determine if assistance is required for the person.

In another aspect there is provided a monitoring system including:
a sensor, mounted in an area, for sensing a parameter of a person in the area; and
a monitoring unit, in communication with the sensor, for:
   receiving sensor signals from the sensor;
   monitoring the sensor signals to determine if one or more rules are satisfied; and
   in the event that one or more of the rules are satisfied, communicating with one or more devices to request assistance for the person.

In another aspect there is provided a method of monitoring a person in an area including:
sensing, using a sensor mounted in an area, a parameter of a person in the area; and
monitoring, using a monitoring unit in communication with the sensor, sensor signals, received from the sensor, to determine if one or more rules are satisfied; and
in the event that one or more of the rules are satisfied, communicating with one or more devices to request assistance for the person.

In another aspect there is provided a method of monitoring a person in an area using a monitoring unit, including:
receiving in the monitoring unit, from a sensor mounted in an area, one or more sensor signals indicative of a parameter of the person in the area;
monitoring, in the monitoring unit, the sensor signals received from the sensor, to determine if one or more rules are satisfied; and
in the event that one or more of the rules are satisfied, communicating with one or more devices to request assistance for the person.

In another aspect there is provided a computer program product for configuring a processing system to monitor a person in an area, wherein the computer program product configures the processing system to:
receive, from a sensor mounted in an area, one or more sensor signals indicative of a parameter of the person in the area;
monitor the sensor signals received from the sensor to determine if one or more rules are satisfied; and
communicate with one or more devices to request assistance for the person in the event that one or more of the rules are satisfied.

In another aspect there is provided an apparatus for monitoring a person in an area, including:
a mountable body for mounting the apparatus to the area;
a sensor at least partially housed by the body for sensing a parameter of a person in the area; and
a monitoring unit, in communication with the sensor and at least partially housed by the body, for monitoring sensor signals indicative of the parameter to determine if assistance is required for the person.

Other embodiments will be described throughout the description of the example embodiments.

### BRIEF DESCRIPTION OF FIGURES

Example embodiments should become apparent from the following description, which is given by way of example only, of at least one preferred but non-limiting embodiment, described in connection with the accompanying figures.

FIG. 1A illustrates a schematic of an example monitoring system for monitoring a person, in an area, wherein a person is standing in the area;

FIG. 1B illustrates a schematic of the monitoring system of FIG. 1A, wherein the person has fallen in the area;

FIG. 1C illustrates a schematic of another example of a monitoring system for monitoring a person in an area, wherein a person is standing in the area;

FIG. 1D illustrates a schematic of the monitoring system of FIG. 1C, wherein the person has fallen in the area;

FIG. 2 illustrates a flowchart representing an example of a method for monitoring a person in an area;

FIG. 3A illustrates a block diagram of an example processing system;

FIG. 3B illustrates a block diagram of an example system including the monitoring system of FIG. 1A utilising the processing system of FIG. 3A, for monitoring a person in the area;

FIG. 3C illustrates a block diagram of a further example system including the monitoring system of FIG. 1C utilising the processing system of FIG. 3A, for monitoring a person in the area;

FIG. 4 illustrates a further flowchart representing an example of a more specific method for monitoring a person in the area;

FIGS. 5A and 5B depicts an example of a sensor device including a sensor for sensing a person in the area;

FIG. 5C depicts an example of a sensor device including a light and one or more sensors for sensing a person in the area;

FIG. 6 depicts a further example of a sensor device including a light and one or more sensors for sensing a person in the area;

FIG. 7A depicts a further example of a sensor device including a light and one or more sensors for sensing a person in the area;

FIG. 7B depicts a further example of a sensor device including a light and one or more sensors for sensing a person in the area;

FIG. 8 illustrates a perspective view of an example of a fitting for coupling a sensor device to a fixture;

FIG. 9 illustrates a side view of an example of a fitting for a sensor device used for sensing a person in the area;

FIG. 10 illustrates a perspective view of an example sensor device;

FIG. 11 illustrates a block diagram of an example of a sensor device; and

FIG. 12 illustrates a perspective view of an example of the monitoring device.

### DESCRIPTION OF PREFERRED EMBODIMENTS

The following modes, given by way of example only, are described in order to provide a more precise understanding of the subject matter of a preferred embodiment or embodiments. In the figures, incorporated to illustrate features of an example embodiment, like reference numerals are used to identify like parts throughout the figures.

Referring to FIG. 1A there is shown a schematic of an example of a monitoring system 100 for monitoring a person 1000 in an area 2000. In particular, the monitoring system 100 includes a sensor device 110 and a monitoring device 120. The sensor device 110 is mounted in the area 2000 and configured for sensing one or more parameters of the person 1000 in the area. The monitoring device 120 is in communication with the sensor device 110 and is configured for receiving data indicative of sensor signals from the sensor device 110, monitoring the sensor signals to determine if one or more rules are satisfied, and in the event that one or more of the rules are satisfied, communicating with one or more devices 330, 340, 350 to request assistance for the person.

As the sensor device 110 is mounted within the area 2000 rather than being personally worn, situations where the person 1000 may require assistance when they are not wearing a sensing device are alleviated.

As shown in FIGS. 1A and 1B, an apparatus 105 can be provided which includes the sensing device 110 and the monitoring device 120. The apparatus 105 may be mounted to an elevated surface relative to a floor surface, such as the ceiling surface of the area or coupled to an elevated device such as a light fixture or the like. The apparatus 105 may include a housing which at least partially houses the sensor device 110 and the monitoring device 120. However, as will be discussed in further detail below with relation to FIGS. 1C and 1D, the monitoring device 120 can alternatively be located remotely to the sensor device 110.

Referring to FIGS. 1C and 1D, there is shown a schematic of another example of a monitoring system 100 for monitoring the person 1000 in the area 2000. In particular, the sensor device 110 and the monitoring device 120 are located remotely relative to each other rather than the integrated design of FIGS. 1A and 1B. The sensor device 110 can be mounted to an elevated position such as being mounted in the area 2000 or coupled to an elevated device such as a light fixture or the like. The monitoring device 120 can be located adjacent an electrical power supply in order to access electrical power. As will be appreciated the monitoring device 120 can be positioned anywhere convenient within or adjacent the area although if wireless communication is utilised, the monitoring device 120 may need to be located within a wireless communication proximity of the sensor device 110. Preferably, the sensor device 110 is in wireless communication with the monitoring device 120. In particular, the sensor device 110 wirelessly transfers data 115 indicative of the one or more sensor signals to the monitoring device 120. As will be discussed in more detail later, the monitoring device 120 can transfer data to the sensor device 110 in order for the sensor device 110 to perform particular functions and/or configuration.

As will be appreciated from FIGS. 1A to 1D, the monitoring system 100 may include a plurality of sensor devices 110 forming a network 109 within an area for monitoring a person 1000 within multiple areas of the area 2000. Neighbouring sensor devices 110 of the network 109 may be spaced apart a sufficient distance to provide effective monitoring in the area 2000. As will be appreciated from above, the network 109 may include one or more apparatus 105.

Referring to FIG. 2, there is shown a method 200 of monitoring a person 1000 in the area 2000. In particular, at step 210 the method 200 includes sensing, using the sensor device 110 mounted in the area 2000, a parameter of a person 1000 in the area 2000. At step 220, the method 200 includes monitoring, using the monitoring device 120 sensor signals generated by the sensor device 110 to determine if one or more rules are satisfied. At step 230, the method 200 includes the monitoring device 120 communicating with one or more devices 330, 340, 350 to request assistance for the person 1000 in the event that one or more of the rules are satisfied.

The monitoring device 120 can be provided in the form of a processing system. In this regard, it will be appreciated that a computer program product can also be provided to configure the monitoring device 120 to monitor the person 1000 in the area 2000. In particular, the computer program product includes executable instructions which when executed configure the monitoring device 120 to monitor the sensor signals generated by the sensor device 110 to determine if one or more rules are satisfied, and communicate with one or more devices 330, 340, 350 to request assistance for the person in the event that one or more of the rules are satisfied.

Referring to FIG. 3A there is shown a block diagram representing a suitable processing system 300 for use as the monitoring device 120. In particular, the processing system 300 is formed from a processor 310 coupled to a memory 311, an optional input/output device 312 such as a keyboard and display or the like, and an interface 313 via a bus 314. It will be appreciated that a wide range of processing systems 300 may be used as the monitoring device 120 and that the processing system 300 may be a microcontroller, a standard generalised computer system, or alternatively a custom processing unit such as a Field Programmable Gate Array (FPGA).

The processor 310 of the monitoring device 120 executes software stored in the memory 311 to monitor the sensor signals to determine if one or more rules are satisfied. In the event that one or more rules have been satisfied, the monitoring device 120 can communicate, via the interface 313 and the one or more intermediary networks, with one or more of the remote devices 330, 340, 350 indicating that assistance is required for the monitored person 1000.

Referring to FIG. 3B there is shown a block diagram representing a first example of system 10 for monitoring a person 1000 in an area 2000. The system 10 illustrated in FIG. 3B relates to an apparatus 105 at least partially housing a sensor device 110 and monitoring device 120 therein. As shown in FIG. 3B, a number of components of the system 10 are in communication with the monitoring device 120 via the interface 313.

In particular, the interface 313 of the monitoring device 120 is in electrical communication with the sensor device 110 that is at least partially contained in the housing of the apparatus 105. Sensor signals received by the monitoring device 120 from the respective sensor device 110 can be processed by the monitoring device 120 to determine if assistance is required. In one form, the sensor device 110 may include one or more sensors such as one or more ultrasonic sensors, rangefinders, passive infrared sensors, depth cameras, 3D scanners, one or more 3D sensors, image sensors or the like.

The interface 313 may be in electrical communication with a communication module 325 to enable communication with one or more remote devices. The communications module 325 of the monitoring device 120 allows communication with a number of remote communication devices 330, 340, 350 via one or more networks 320, such as a telephone via a telephone network, a mobile phone via a mobile phone network, a pager via a pager network, and/or a computer via a computer network such as a LAN (Local Area Network) or a WAN (Wide Area Network) such as the Internet. The monitoring device 120 is able to transfer an assistance request to one or more of the communication devices, via one or more communication mediums, in the event that the monitoring device 120 determines that the one or more of the rules have been satisfied. The communication module 325 also enables the monitoring device 120 of a respective apparatus 105 to communicate with another monitoring device 120 of another apparatus 105 in the network 109 of the area.

The communications module 325 of the monitoring unit 120 of FIG. 3B preferably utilises wireless communication such GPRS (General Packet Radio Service), UMTS (Universal Mobile Telecommunications System), GSM (Global System for Mobile Communications), radio, IEEE 802.15.4, or the like in order to allow the monitoring device 120 to communicate with one or more remote devices. The communications module 325 may utilise various communications protocols. In one example, X10 standard may be utilised to enable communication between devices. However, it will be appreciated that a wired communication medium to transfer data between devices may additionally or alternatively be used by the monitoring unit 120.

Referring to FIG. 3C there is shown an alternate example of the system 10, wherein the monitoring device 120 is located remote relative to the sensor device 110 as discussed with relation to FIGS. 1C and 1D. As shown in FIG. 3C, the external interface 313 of the monitoring device 120 can be in communication with one or more sensor devices 110 mounted throughout the area 2000. In this particular configuration, the monitoring device 120 is able to receive data indicative of a plurality of sensor signals from one or more of the sensor devices 110 which contrasts to the system of FIG. 3B wherein each apparatus 105 includes a dedicated monitoring device 120. The monitoring device 120 of FIG. 3C can then perform processing on the plurality of sensor signals indicated by the data received from the one or more sensor devices 110. The data indicative of the sensor signals may be received by the monitoring device 120 via a wireless or wired communication medium, examples of which have been discussed above. In one form, WiFi or Bluetooth can be used to enable wireless communication between the one or more sensor devices 110 and the monitoring device 120. The communication module 325 of the monitoring device 120 enables two way data transfer between the monitoring device 120 and one or more of the sensor devices 110.

The monitoring device 120 of the system 10 illustrated in FIG. 3C may be mounted to a surface of the area 2000, wherein the input/output device 312 of the monitoring device 120 may be provided in the form of a control interface, such as a touch screen or the like, which allows a user to configure the operation of the system 10, although it will be appreciated that this is not essential. As will be discussed in further detail below, the monitoring device 120 for either system 10 illustrated in FIG. 3B or 3C may additionally or alternatively be configured remotely by a remote device, such as via a remote, computer, for example a server processing system.

For the systems 10 illustrated in FIGS. 3B and 3C, each monitoring device 120 can store in memory a plurality of rules which can be used by the processor 311 of the monitoring device 120 to determine if the person requires assistance. The rules may include the use of one or more thresholds, wherein the processor 311 of the monitoring device 120 executes software representing the rules to determine if the person 1000 requires assistance. Both the rules and thresholds can be set by a user.

The rules may be applied by the monitoring device 120 to collect one or more parameters and to detect a variety of different events which are indicative of the person 1000 requiring assistance.

For example, the monitoring device 120 may include a rule to determine if a person has not left or entered a particular zone of the area for a predefined temporal threshold. For example, a sensor device 110 located outside a bedroom in the area is to transfer, to the monitoring device 120, data indicative of a sensor signal within a twenty-four hour period of the previously received sensor signal for the respective sensor device 110, otherwise assistance is determined to be required by the monitoring device 120. Similar rules can be applied for other rooms, areas or objects in the area 2000 such as a bathroom, chair, bed, etc.

In another example, the monitoring device 120 may have stored in memory a rule to determine if the monitored person 1000 is lying on the floor of the area 2000, as illustrated in FIGS. 1B and 1D. For this particular rule, a combination of thresholds may need to be satisfied for assistance to be requested. In particular, the rule may include a first threshold in relation to the sensed vertical height of the monitored person 1000, and a second threshold may be defined in relation to a maximum time period (i.e. 60 seconds) which the monitored person 1000 remains below the vertical height threshold. In the event that the monitored person 1000 stands prior to the temporal threshold being exceeded, the rule has not been satisfied and thus no assistance is required. Particular thresholds indicative of particular positions of the person (i.e. standing, crouching, and lying) may be stored by the monitoring device 120 such that the monitoring device 120 can differentiate events that do and do not require assistance.

In a further example, a rule may be defined which determines if the monitored person 1000 exits the area 2000. In one form, the monitoring device 120 can utilise the data 115 indicative of the sensor signals received from the network 109 to determine whether the monitored person 1000 entered or exited a doorway of the area 2000. For example, if one or more sensor devices 110 adjacent a doorway fail to transfer data indicative of a sensor signal to the monitoring device 120, then the monitoring device 120 can infer that the monitored person 1000 has exited the area 2000 rather than travelled past the doorway and into a neighbouring area of the area 2000. In one form, the rule may be defined such that the monitoring device 120 requests assistance once the monitored person 1000 leaves the area 2000. In another form, a temporal threshold may also be applied, wherein the monitored person 1000 has a period of time to enter the area 2000. In the event that the temporal threshold is exceeded, both components of the rule are satisfied, wherein assistance is requested by the monitoring device 120. In another form, a temporal threshold may also be applied, wherein the monitoring device 120 requests assistance if the monitored person 1000 leaves the area at particular times, such as during the night.

In a further variation, the data 115 indicative of the sensor signals may be used by the monitoring device 120 to determine various derived parameters relating to the monitored person 1000 which can then be used for determining if one or more rules are satisfied. For example, the sensed vertical height of the monitored person over a period of time can be used by the monitoring device 120 to determine a presence of the person, a trajectory of movement of the monitored person, a velocity of the monitored person, and an acceleration of the monitored person. Other parameters may also be determined using the data 115 indicative of the sensor signals such as the distance covered by the monitored person within the area. Thus, different types of thresholds can be utilised by the one or more rules of the monitoring device 120 to determine if assistance is required. It will be appreciated that such data can also be used to determine trends in the movement habits of the monitored person 1000.

The rules and the thresholds can be configured by a user such that the monitoring system 100 is customised for the particular person to be monitored. As discussed above, the monitoring device 120 can include a control interface which allows a user to customise the monitoring device 120, wherein rules and thresholds may be set by the user. The customisation of the monitoring device 120 via the control interface may require authorisation, for example correct entry of a username and/or password may need to be input by the user in order to be able to customise the operation of the monitoring device 120.

In an additional or alternate form, the monitoring device 120 can be remotely configurable. In particular, the user may be able to remotely configure the monitoring device 120 via a remote processing system 360 which is in communication with the monitoring device 120.

The remote processing system 360 for enabling remote configuration of the monitoring system 100 can be provided in the form of a web-server 360 which hosts a web-portal accessible via a computer network, such as the Internet. The user is able to interact with the web-portal via a user processing system to customise the operation of the monitoring system 100. Configuration data indicative of the user configuration of the monitoring system 100 can then be transferred to the monitoring device 120, wherein at least some of the configuration data is stored in memory or to configure the monitoring device 120. In one form, whilst the web-server 360 may be in data communication with the monitoring device 120, other intermediary processing systems may be located between the web-server 360 and the monitoring device 120 for a number of reasons, such as security. The user is able to configure at least one of the operation of the sensor device 110 and the monitoring device 120. As discussed above in various examples, one or more rules and one or more thresholds used by the monitoring device 120 can be set by the remote processing system 360. Additionally or alternatively, the operation of the sensor device 110 can be set via the remote processing system, such as configuring prioritisation of one or more sensor devices 110, or a sensing frequency for one or more of the sensor devices or specific sensor components of particular sensor devices, as will be discussed in more detail below.

Similarly to the control interface of the monitoring device 120, authorisation of the user to allow remote configuration of the monitoring system 100 is preferably required, wherein the user may be required to log into the web-portal using a username and/or password. Upon successful authentication, the user is then presented, via the web-portal, with a number of configurable options for the monitoring device 120.

The web-server 360 may include a storage device 365 in the form of a database for storing particular data for operating and configuring the system 10. In particular, the database 365 may include configuration data indicative of the one or more rules and the one or more thresholds which are used to determine if assistance is required. The configuration data can also be indicative of a layout of the network 109 within the area 2000 which can be utilised by the monitoring device 120 to determine whether a person 1000 has moved into a neighbouring portion of the area 2000 or whether an event has occurred which may require assistance. The configuration data can also be indicative of settings for one or more of the sensor devices 110 of the monitoring system 100.

Once the particular configurable options have been input and stored in the database 365, the web-server 360 can transfer configuration data to the monitoring device 120 via the external interface 313. In the event that the configuration data includes one or more settings for the monitoring device 120, the monitoring device 120 is reconfigured according to at least a portion of the configuration data received from the web-server 360. If at least a portion of the configuration data includes one or more settings for one or more sensor devices 110, the monitoring device 120 transfers at least some of the configuration data to the relevant sensor device(s) 110 wherein the respective sensor device(s) 110 are reconfigured according to the configuration data received from the monitoring device 120.

The configuration data which is defined by the user interacting with the web-portal and the control interface is preferably synchronised. In particular, once the configuration data is altered in the database 365 via use of the web-portal or in the memory 311 of the monitoring device 120 via use of the control interface, the altered configuration data is transferred to the monitoring device 120 such that the configuration data stored in the memory 311 of the monitoring device 120 and the database 365 of the web-server 365 is synchronised.

The web-portal and/or the control interface can allow the user to configure a number of features of the operation of the system 10, as discussed below.

In one example, the web-portal and/or the control interface may allow the user to define one or more rules and/or thresholds for use by the monitoring device 120. In an additional or alternate form, the web-portal and/or the control interface may present one or more predefined profiles, associated with a number of settings such as predefined rules and thresholds, for particular types of people 1000 which can be monitored. The pre-defined configuration of the system 10 may be set for particular conditions associated with people who commonly require some form of monitoring, such as Parkinson's disease or dementia. The user interacting with the web-portal or the control interface may select one or more of the pre-set profiles for operation, and/or customise particular settings such as rules and/or thresholds whilst retaining particular other predefined settings of the selected profile.

In another form, the user is able to select the communication devices 330, 340, 350 which one or more people are able to be alerted in the event that assistance is required. In one form, the user may be able to define a contact list including a plurality of devices associated with particular contact people, wherein the contact list can be prioritised by the user. In the event that a message sent to one of the devices is unsuccessfully received, such as a telephone call ringing out, the monitoring device 120 selects the next device of highest priority as indicated in the priority list until a message is received successfully.

In another option, the user is able to associate one or more communication devices 330, 340, 350 with particular rules. In particular, in the event that a particular rule detects whether a person has left the area, a communication device associated with a person located nearby the area may be set as the appropriate person to receive the assistance request. In contrast, if a different rule detects whether a person has fallen and lays unconscious within the area, a contact at the hospital may be set as the appropriate contact for this specific rule. It will be appreciated that a prioritised list of communication devices may be associated with each rule to allow for, a number of alternative assistance requests to be sent in the event that a previous assistance request has been unsuccessfully received.

In another option, the configuration data may be indicative of prioritised sensor device 110 in the network 109. Specifically, a more highly prioritised sensor device 110 may perform a sensing activity at a higher frequency compared to a lower prioritised sensor device 110 in the network 109. The prioritisation of sensor devices 110 in the network 109 may be set by the user in accordance with the habits of the monitored person 1000 in the area 2000. The web-portal provided by the web-server 365 may be utilised by user to configure the prioritisation of the relevant sensor device 110 in the network 109, or alternatively to set the sensing frequency of one or more sensor devices 110 in the network 109.

In another option, the user is able to define particular rules and thresholds for particular portions of the area 2000. For example, different thresholds may be set for different levels (i.e. 1^{st} level, 2^{nd} level, etc) of a house. In circumstances where a particular sensor device 110 is associated with a set of stairs, the monitoring device 120 may be configured to take into account the expected rates of change of the monitored person 1000 ascending or descending the stairs.

In another option, the period of time which the system 10 is to be operative can be selected by the user. For example, in periods where the area 2000 may be unoccupied for an extended period of time, the user may be able to disable the operation of the system 10.

Additionally, the system 10 can be configured to monitor multiple people 1000 in the area 2000. In particular, differing thresholds may be utilised for the multiple people in the area. The pattern of movement sensed by the plurality of sensor devices 110a-110n can be used by the monitoring device 120 to differentiate between the plurality of monitored people such that the differing rules and thresholds can be applied accordingly.

Referring to FIG. 4 there is shown a further flowchart representing an example method 400 for monitoring a person in an area 2000. For clarity, the method 400 disclosed in relation to FIG. 4 relates to the application of a single rule which detects if a user has fallen in the area. However, it will be appreciated that different rules, as well as a plurality of rules, can be applied by the monitoring device 120 and that FIG. 4 only illustrates the application of a single rule for the purposes of clarity. Furthermore, the method 400 disclosed in relation to FIG. 4 is applicable to the system 10 discussed in relation to FIG. 3B. However, it will be appreciated that alternate system variations, such as the system disclosed in FIG. 3C or variants thereof, can also be used generally in relation to method 400 and that FIG. 4 only illustrates the application the method 400 in relation to the system of FIG. 3B for the purposes of clarity.

At step 410, the method 400 includes sensing the distance to a monitored person in the area using the sensor device 110. The area which a distance is measured to the person is generally referred to as an ‘active area’.

At step 420, the method 400 includes the monitoring device 120 determining if the rate of change in the distance to the monitored person 1000 (herein referred to as the rate of change) exceeds a threshold. It will be appreciated that previous recordings of distances previously collected are used to determine the rate of change. In the event that the rate of change does not exceed the threshold, the method proceeds back to step 410 to continue collecting sensed distances. In the event that the rate of change has exceeded the threshold, the method 400 proceeds to step 430.

At step 430, the method 400 includes the sensor device 110 sensing further distances to the person in the active area. At step 440, the method 400 includes the monitoring device 120 determining if the rate of change, taking into consideration the newly sensed signals, are indicative of a reduction in the rate of change. In the event that there has been no reduction in the rate of change, the method 400 proceeds to continue collecting sensed distances at step 430. Once a reduction in the rate of change has been determined, the method 400 proceeds to step 450.

At step 450, the method 400 includes the monitoring device 120 determining if a rate of change in a neighbouring area has exceeded the threshold. In one form, data may be received by the respective apparatus 105 from a neighbouring apparatus 105 in the network 109 indicative of whether there has been a rate of change in the neighbouring area. In the event of a positive comparison, the method 400 proceeds back to step 455, wherein the monitoring device 120 of the newly active area monitors the respective sensor device 110 to monitor the person 1000 as it is apparent that the rate of change sensed is indicative of the person having left the previously active area. The method 400 then proceeds back to step 410. In the event of a negative comparison, the method 400 proceeds to step 460.

At step 460, the method 400 includes the monitoring device 120 storing, according to newly sensed signals received from the active sensor device 110, a new distance between the monitored person and the sensor device 110.

At step 470, the method 400 includes determining whether the monitored person 1000 responds. In the event that the monitored person 1000 responds successfully, such as standing or the like, then the method 400 proceeds back to step 410. In the event that the monitored person 1000 does not respond, the method 400 proceeds to step 480.

At step 480, the method 400 includes the monitoring device 120 performing an assistance request function, wherein the monitoring device 120 may transfer an assistance request to one or more communication devices. In particular, the monitoring device 120 may be configured to send a message to one or more recipient devices 330, 340, 350 utilising the one or more networks 320 which the interface 313 is in communication therewith. In one form, the message may take the form of a pager message for receipt by a pager device 330, an SMS/MMS message for receipt by a mobile phone 340, an automated telephone call receivable by a telephone 340, an email message receivable by a processing system 350, an update on a website viewable by a processing system 350, or any other form of communication medium for a communication device which is in communication with the monitoring device 120.

The assistance request may provide information regarding the area 2000, such as the physical address of the area, the time which the detected event occurred (i.e. a fall, non-movement of the monitored person, the person left the area), the name of the monitored person 1000, any medical details for the monitored person 1000, and any other further information which may be useful to enable another person to assist with any injuries which the monitored person may have suffered. The monitoring device 120 may have stored in memory some of these details which are retrieved to generate the assistance request.

In another option, in the event that an assistance request sent to the one or more devices 330, 340, 350 fails to be received successfully, one or more lights 540 associated with the sensor device 110, as will be discussed later in relation to FIGS. 6 to 11, can be operated in a flashing mode such that a neighbour or the like may be drawn to attention that an accident has occurred. In other forms, the sensor device 110 may include a speaker 541 which is additionally or alternatively operated to emit an audible signal to draw attention to the accident. In order for the lights 540 and/or the speaker 541 to be actuated in response to the monitoring device 120 determining that assistance is required, the monitoring device 120 transfers assistance data to one or more sensor devices 110. A processor of the sensor device 110 actuates the speaker 541 and/or the light 540 in response to receiving the assistance data. In one form, the speaker 541 and/or lights 540 of one or more sensor devices 110 associated with one or more rules that are satisfied at the monitoring device 120 may be actuated. For example, if a particular sensor device 110 generates sensor signals indicative of the monitored person 1000 suffering a fall, the speaker 541 and/or lights 540 of the respective sensor device 110 receives the assistance data. This configuration may help assist people attending the assistance request to locate the monitored person 1000 in the area 2000.

A number of different parameters can be sensed by each sensor device 110. Each sensor device 110 is preferably able to detect the distance between the respective sensor device 110 and the person 1000 in the area 2000, and/or a position of the monitored person 1000 relative to the sensor device 110.

In one form, each sensor device 110 may include one or more distance detecting sensors 1120. In one example, each sensor device 110 may include one or more ultrasonic sensors. Each ultrasonic sensor emits a first ultrasonic signal 111 as shown in FIGS. 1A to 1D. A second ultrasonic signal, as shown in FIGS. 1A to 1D, is reflected from the person 1000 and captured by the ultrasonic sensor of the sensor device 110. The ultrasonic sensor determines the time between when the first ultrasonic signal 111 was emitted and when the second ultrasonic signal 112 was collected, thereby allowing the sensor device 110 to determine the distance between the person 1000 and the sensor device 110.

Additional or alternative types of distance detecting sensors may be included in at least some of the sensor devices 110 such as a laser rangefinder, a depth sensor, a 3D scanner, a 3D sensor or an image sensor. Specific arrangements of sensors will be described in more detail in relation to FIGS. 5A to 12 below. As discussed above, other parameters may be calculated from a plurality of captured sensor signals such as a trajectory, a speed, and an acceleration of the monitored person 1000.

Each sensor device 110 of the network 109 can be configured to perform a sensing function on a regular periodic basis. In one example the sensor device 110 is configured to sense the distance to the person at a frequency of approximately 1 Hz, although other frequencies can be used. As has been discussed above, the frequency which the sensor device 110 senses the distance to the person in the area can be adjusted. As illustrated in FIGS. 1A to 1D, the sensor device 110 can detect the distance to the person 1000 in a substantially circular profile which is emitted in a conical-like profile, however, other profiles of the detectable area can be achieved with various arrangements of sensor components, as will be discussed in more detail below.

In one variation, the monitoring device 120 can be configured to dynamically adjust the operation of one or more sensor devices 110 of the network 109. In one form, the dynamic adjustment of the operation of the sensor device(s) 110 may occur if one or more operational rules are determined to be satisfied by the monitoring device 120. In one example, the monitoring device 120 can be configured to dynamically adjust the frequency that the respective sensor device(s) 110 perform a sensing activity based upon a historical analysis of received sensor signals. In particular, the monitoring device 120, can determine which sensor devices 120 of the network 109 are associated with transferring a larger than average proportion of the sensor signals 113 to the monitoring device 120, wherein the monitoring device 120 can configure the respective sensor device 110 to conduct a sensing activity at a higher than average frequency. For example, if a particular sensor device 110 conducts an average sensing activity at 1 Hz, the respective sensor device 110 may be configured by the monitoring device 120 to conduct the sensing activity at double the frequency, i.e. 2 Hz, in the event that a higher than average proportion of sensor signals 113 are received by the monitoring device 120 from the respective sensor device 110. Similarly, particular sensor devices 110 which transfer a lower than average number of sensor signals 113 over a period of time may be configured by the monitoring device 120 to perform the sensing activity at a lower frequency (i.e. 0.5 Hz). The monitoring device 120 may be configured to dynamically determine the average number of sensor signals 113 received from a plurality of sensor devices 110, and then automatically adjust the frequency which the sensor activity is performed by one or more respective sensor devices 110a-110n according to historical records of sensor signals 113 received by the monitoring device 120. This dynamic reconfiguration of the frequency which sensor devices 110 perform a sensing function is generally utilised such that entrance and exit points in the monitorable area have higher rates of sensing frequency. Configuration data is generated and transferred to by the monitoring device 120 to the relevant sensor devices 110. In addition, the database 365 is synchronised with the dynamic changes implemented with one or more sensor devices 110.

FIG. 5A through to FIG. 11 show various implementations of the sensor device 110 which can be used for monitoring a person in an area. It will be appreciated that the sensor devices 110 shown in FIG. 5A through to FIG. 11 can be provided in the form of apparatus 105 with an integrated monitoring device 120.

Referring more specifically to FIGS. 5A, 5B and 5C the sensor devices 110 are provided with ultrasonic sensors 530 that are mounted within a fitting 505. The ultrasonic sensors 530 may be supported by a particular medium 510 which allow the ultrasonic signal to be at least partially sensed by the ultrasonic sensors 530 to sense the distance to the person 1000 within the area 2000. As shown in FIG. 5A, the fitting 505 may include a screw thread 520 or grooved engaging surface to effectively mount the sensor device 110 to the elevated surface of the area. As will be appreciated, the sensor device 110 shown in FIGS. 5A and 5B are configured to sit flush with the elevated surface. As shown in FIG. 5C, the sensor device 110 may include one or more sensor components 530 which can be utilised to expand the area which is monitored.

Referring to FIG. 6, there is shown a further sensor device 110 which includes a plurality of sensor components 530 arranged around the perimeter of the fitting to thereby again expand the area which is monitored. A light may be centrally located in the fitting.

Referring to FIG. 8, there is shown an example of a body 800 in the form of a fitting which includes a plurality of sensor mountings 820 for mounting one or more sensors of a sensor device 110. The sensor mountings 820 are equally spaced around a cylindrical body 810 of the fitting 800, wherein the cylindrical body 810 allows for support of a light and the power supply arrangement. Whilst the sensor mounting 820 are shown in FIG. 8 to direct the sensor detecting sensors 1020 in a downward direction, the sensor mountings 820 can be angled outwardly, such as at approximately 45 degrees relative to the vertical.

The body 800 shown in FIG. 8 includes a first coupling arrangement 840 which can couple to a light fixture, and a second arrangement 850 which can couple an electrical light. The body 800 includes an electrical connector which enables electrical connection between an electrical socket of the light fixture and the light. In addition, the electrical power provided via the electrical connector can be used to power the sensor device 110. The first coupling arrangement 840 can include a screw thread or bayonet arrangement for coupling with the light socket of the light fixture, and the second coupling can include a screw thread and bayonet receiving arrangement for coupling with an electrical light. The processing system and communication module of the sensor device 110 can be housed by the body 800. This arrangement illustrated by FIG. 8 provides ease of installation such that a person with little technical experience can install the sensor device 110 without difficulty.

Referring to FIGS. 7A and 7B, there is shown a sensor device 110 which includes one or more sensor components 530 for sensing distance to the person in the area, and one or more lights 540. For ease of installation, the sensor components 530 and the lights 540 of the sensor device 110 share a common electrical power supply interface 720. As shown in FIG. 7A, the one or more sensors 530 may protrude from the panel 730 supporting the one or more lights 540 but is supported by a frame 710, or alternatively the one or more sensors 530 may by fitted flush with the panel 730 as shown in FIG. 7B.

As discussed previously, a laser rangefinder may be used as a distance detecting sensor. In one particular form, as shown in FIG. 9, a sensor device 110 includes a cover 900 behind which is a distance detecting sensor 1120 which may include a rotating mechanism so that the sensor device 110 receives a swept reflected beam 112 generated by the laser rangefinder to yield three dimensional information about that area. Similarly to FIG. 8, the sensor device 110 of FIG. 9 includes a first coupling arrangement 840 for coupling the sensor device 110 to a light fixture and a second coupling arrangement 850 for coupling an electrical light. The sensor device 110 of FIG. 9 can include the electrical connector as explained in relation to FIG. 8.

Referring to FIG. 10 there is shown a perspective view of another example of a sensor device 110. FIG. 11 shows a block diagram of the sensor device 110 illustrated in FIG. 10. The sensor device 110 can include one or more motion detecting sensors 1110 and/or one or more distance sensing devices 1120. The sensor device 110 includes one or more covers 1020 which partially cover a sensing region of one or more of the one or more motion detecting sensors 1110 and/or the one or more distance sensing devices 1120 in order to define a motion sensing region and/or distance sensing region for the sensor device 110. Whilst FIG. 10 shows two covers, the sensor device 110 may include between 2 and 6 covers. The one or more motion detecting sensors and/or the one or more distance sensing devices may be angled downwardly at approximately 45 degrees relative to the horizontal.

As shown in FIG. 11, the sensor device 110 includes a communication Module 1130, a battery 1140, a speaker 541, an LED lamp 540, a microphone 1160 and photosensor 1150. The sensor device 110 includes a microcontroller 1100 which is in electrical communication with the sensors 1110, 1120, the battery 1140, the speaker 541, the LED lamp 540 and the photosensor 1150. The microcontroller 1100 can be configured as shown in FIG. 3 with relation to processing system 300.

In one form, the sensor device 110 has two operating states. In a first state, the motion detecting sensors 1110 are active but the distance detecting sensors are inactive. When a signal is received by the microcontroller 1100 from one or more of the motion detecting sensors 1110, the sensor device 110 operates in a second state wherein the motion detecting sensors 1110 and the distance detecting sensors are active. After the microcontroller 1100 detects a period of time without receiving a signal from one of the sensors 1110, 1120 indicative of monitoring a person whilst operating in the second state, the sensor device 110 switches from the second state to the first state. This configuration is particularly useful with a battery powered sensor device 110 in order to reduce power consumption.

The communication module 1130 of the sensor device 110 enables duplex or full duplex wireless communication with the monitoring device 120. The microcontroller 1100 can configure the communication module 1130 to operate in an inactive mode when the sensor device 110 operates in the first state. The microprocessor 1100 can periodically switch the communication module 1130 to operate in an active mode to transfer a message to the monitoring device 120 to determine if any data is required to be transferred to the sensor device 110. If no data is to be pushed to the sensor device 110, the microcontroller 1100 switches the communication module 1130 to the inactive mode 120 to reduce electrical power consumption. When one of the motion detecting sensors 1110 sense movement, the microcontroller 1100 may switch the communication module 1130 to operate in the active mode.

In one embodiment, the photosensor 1150 is configured to sense the ambient light in the area where the sensor device 110 is installed. The microprocessor 1100 compares the ambient light reading received from the photosensor 1150 against an ambient light threshold stored in memory of the microcontroller 1100, wherein if the reading is equal to or below the threshold, the microcontroller 1100 actuates the LED lamp 540. This is advantageous as the sensor device 110 can operate as a night-light. When the ambient light reading is equal to or above the ambient light threshold, the microcontroller 1100 deactivates the LED lamp 540.

In one embodiment, a user can configure one or more of the sensor devices 110 to operate in a night-light mode. In particular, the user may set configuration data via the portal hosted by the remote processing system 360 or via the monitoring device 120 to set whether one or more sensor devices 110 in the network 109 operate as a night-light. If a sensor device 110 is set to not operate in a night-light mode, the microcontroller 1100 will not actuate the LED lamp 540 in response to receiving a signal from the photosensor 1150 indicative of the ambient light being equal to or less than the ambient light threshold. In the event that the sensor device 110 is set to operate in a night-light mode, the microcontroller 1100 operates as discussed above to actuate the LED lamp 540 if the ambient light signal is equal to or greater than the ambient light threshold.

The sensor device 110 may also include an LED that can be actuated by the microcontroller 1100 on a periodic basis to indicate that the sensor device 110 is operational. The LED can also be actuated during data communication with the monitoring device 110 in order to provide feedback. In the instance of the sensor device 110 depicted in FIG. 10, the ambient light sensor includes the LED which is actuated to indicate that the sensor device 110 is operational.

The microphone 1160 and speaker 541 can be used to establish two way communication between the monitored person and a user of a remote device. In particular, the microphone 1160 can capture sensed audio which is then transferred to the monitoring device 120 and forwarded to the remote device. Additionally, audio data received from the remote device may be transferred by the monitoring device 120 to the respective sensor device 110 and, emitted by the speaker 541.

Referring to FIG. 12 there is shown an example of the monitoring device 120. In particular, the monitoring device 120 includes a housing which houses therein the processing system 300. The monitoring device 120 includes an antenna 1220 which protrudes from the housing and is in electrical communication with the communication module of the monitoring device 120. The monitoring device 120 includes an electrical connector 1210 to electrically connect the monitoring device 120 to an electrical power supply within the area 2000. Generally, the monitoring device 120 is located within 15 metres of the one or more sensor devices 110.

Upon connecting the monitoring device 120 to the power supply, the monitoring device 120 undergoes an initialisation process that is stored in memory. In particular, the monitoring device detects one or more sensor devices 110 which the monitoring device can communicate therewith. The monitoring device 120 transfers the list of sensed sensor devices 110 to the web-server processing system 360. The user can then visit the website hosted by the monitoring device to view the sensed devices 110 and to configure the various settings of the system 10.

In an alternative configuration, the monitoring device 120 may communicate with a LAN such as a private computer network within the area 2000. The user may be able to view an electronic page viewable via a web-browser using a computer which is part of the LAN. The processing system 300 of the monitoring device 120 operates as the server processing system 360. Thus, in this configuration, a dedicated server processing system 360 for the system 10 is not required.

The monitoring device 120 in this initialisation process can also determine a communication frequency for communication with one or more of the sensor devices 110. In particular, the monitoring device 120 may detect one or more frequencies in a particular frequency spectrum which has minimal interference based on received signal strength indicator (RSSI) from other wirelessly communicating devices. Upon detecting the one or more frequencies, the monitoring device 120 transfers data to the one or more sensor devices 110 indicative of the one or more frequencies.

In one embodiment, the monitoring device 120 can transfer configuration data to one or more sensor devices 110 to alter the power of the communication signals emitted by the respective one or more sensor devices 110. In particular, the monitoring device may sense the signal strength of communication signals received from each sensor device 110 in the network 109. Due to the layout of the network 109, particular signals received from particular sensor device 110 may be unnecessarily high. In order to preserve electrical consumption by the sensor devices 110, the monitoring device 120 can transfer configuration data to one or more of the sensor devices 110 to alter the signal strength of signals emitted by the communication module 1130 of the respective one or more sensor devices 110. The microcontroller 1100 of each sensor device which receives such configuration data can then dynamically alter the power of the emitted signals emitted by the communication module 1130.

In one variation, one of more sensor devices 110 may be in electrical communication with one or more light switches of the area. The light switches may be used to control particular operations of the system 10.

In particular, in one form, an assistance request may be initiated via selective operation of one or more lights 540 of the sensor device 110/apparatus 105 discussed in relation to FIGS. 5A to 10. In particular, in the event that the monitored person 1000 wishes to initiate an assistance request, the monitored person 1000 can operate the light switch associated with the light 540 in a particular sequence. For example, the pre-defined sequence to initiate the assistance request may include flicking on and off the light switch quickly three times within a specific time period, wherein the monitoring device 120 detects the operation of the light switch 540 in the specific sequence, and thereby initiates the assistance request with one or more of the communication devices 330, 340, 350.

In another form, the one or more light switches may be operated by a user to test the operation of the system 10. For example, similar to above, the user may selectively operate one of the light switches in a pre-defined sequence to initiate the testing operation of the system 10. The system 10 may then perform one or more testing functions. In the event that the testing function is performed successfully the one or more lights 540 of the apparatus may flash to indicate a successful test operation of the system 10.

In another variation, the monitoring device 120 may store, in a log file, particular sensor signals which can be interpreted to infer particular events or conditions for the monitored person 1000. The log file is indicative of historical data which can be downloaded remotely to a remote processing system, potentially via the web-portal, to allow remote analysis. The log file can be used to determine if a particular trend is occurring over an extended period of time. In particular, sensor signals received from a sensor 110 located adjacent to a doorway to a bathroom may be stored by the monitoring device 120, wherein this information could be used to determine if the monitored person is suffering from a particular impairment or condition. Additionally or alternatively, the monitoring device 120 can use the log file to determine if there is an increased risk of harm for the person such as an increased risk of a fall or injury. This log file can then be extrapolated, charted, and analysed by health professionals. Other information that may be stored and interpreted from the log file may include the average speed which the monitored person 1000 travels within the area 2000, or the travel pattern of the person 1000 within in the area 2000. In the event that there is a sudden decrease in the average speed which the monitored person travels within the area, or a particular pattern of movement of the monitored person as indicated by the analysis of the log file, a health professional may be able to detect a particular condition has occurred or worsened for the monitored person 1000 and take appropriate action.

In another variation, the system 10 may be initialised wherein the sensor devices 110a-110n transfer sensor signals indicative of the area 2000 without the monitored person 1000 being present. This initialisation data can then be used by the monitoring device 120 as a benchmark dataset for determining whether a change in distance within the area 2000 has occurred which is indicative of a monitored person 1000 being present within the area.

It will be appreciated that at least some of the sensor devices 110 may include an electrical power interface in order to operate using electrical mains. However, in an additional or alternate form, the sensor device 110 may include a battery power supply. It will be appreciated that the sensor device 110 may include various circuits to regulate power supply.

In another embodiment, one or more signals indicative of the sensed audio captured by the microphone 1160 can be used by the one or more rules to determine if assistance is required for the person. For example, if the sensed audio is louder than a threshold or the audio is louder than a threshold for a certain percentage over a particular period of time, the monitoring device 120 can initiate an assistance request.

In another variation, the sensor device may utilise the distance detecting sensor 1120 as a motion detecting sensor 1110. In particular, the detection in the change of distance to the person by the distance detecting sensor 1120 can be indicative of motion of the monitored person 2000.

In another variation, the monitoring device 120 may communicate with one or more devices to request assistance via the server processing system 360.

In particular embodiments, the sensor device 110 can include or is part of a smoke detector or a gas detector. In one embodiment, the sensor device 110 can be housed within a smoke detector housing which includes a smoke detector. In other embodiments, the sensor device 110 can be housed within a gas detector housing which includes a gas detector.

In another embodiment, one or more of the sensor devices 110 include a 1 or 2 dimensional thermal sensor 1170 to detect at least one of ambient temperature and heat from the monitored person 2000. Data received by the monitoring device 120 indicative of ambient temperature and heat from the monitored person 2000 can be used detect the presence and/or movement of the monitored person and can be used by the one or more rules to determine if assistance is required.

It will be appreciated that the determination by the monitoring device 120 regarding whether the monitored person 1000 requires assistance is an estimation based on the sensed parameters.

It will be appreciated that the area 2000 which the one or more sensor devices 110 are mounted within may be any type of area. For example, the one or more sensor devices 110 may be used for domestic purposes where the area may be a building or dwelling. The area 2000 may also be used in workplaces or temporary workplaces in order for workplace safety. Particular examples of workplaces or temporary workplaces that may have one or more sensor device 110 mounted therein include a sewer or mine. The one or more sensor devices 110 can be used in other areas such as parks, footpaths, roads, and train stations.

The above embodiments may take the form of an entirely hardware embodiment, an entirely software embodiment, firmware, or an embodiment combining software and hardware aspects.

Many modifications will be apparent to those skilled in the art without departing from the scope of the present invention.

1. A monitoring system including:
a sensor device, mounted in an area, for sensing a person in the area; and
a monitoring device, in communication with the sensor device, for:
receiving data indicative of one or more sensor signals from the sensor device;
monitoring the sensor signals to determine if one or more rules are satisfied; and
in the event that one or more of the rules are satisfied, communicating with one or more devices to request assistance for the person.

2. The monitoring system according to claim 1, wherein the sensor device senses motion of the person in the area, wherein the one or more rules use a presence or lack of motion sensed to determine if the person requires assistance.

3. (canceled)

4. The monitoring system according to claim 1, wherein the sensor device senses one or more distances between the person and the sensor device.

5. The monitoring system according to claim 4, wherein the one or more rules use the one or more distances sensed to determine if the person requires assistance.

6. The monitoring system according to claim 5, wherein the monitoring device uses the one or more distances sensed to determine one or more derived parameters, the one or more derived parameters include at least one of:
a presence of the person;
a position of the person;
a trajectory of movement of the person;
a velocity of the person; and
an acceleration of the person;
wherein the one or more rules use the one or more derived parameters in order to determine if the person requires assistance.

7. The monitoring system according to claim 1, wherein the sensor device includes:
a motion sensing device for sensing motion of the person; and
a distance sensing device for sensing a distance of the person relative to the sensor device.

8. The monitoring system according to claim 7, wherein the sensor device operates in:
a first state wherein the motion sensing device is active and the distance sensing device is inactive; and
a second state wherein the distance sensing device is active in response to the motion sensing device sensing the motion of the person in the first state.

9. The monitoring system according to claim 8, wherein the sensor device switches from operating in the second state to the first state in the event that the motion sensing device fails to sense motion for a threshold period of time whilst the sensor device operates in the second state.

10. The monitoring system according to claim 7, wherein the motion sensing device is one or more passive infrared sensors.

11. The monitoring system according to claim 7, wherein the distance sensing device is at least one of:
one or more ultrasonic sensors;
one or more rangefinder sensors;
one or more depth sensors;
one or more 3D sensors;
one or more 3D scanners; and
one or more image sensors.

12-50. (canceled)

51. A monitoring device for monitoring whether a person in an area requires assistance, wherein the monitoring device includes a processing system configured to:
receive, from a sensor device mounted in the area, data indicative of one or more sensor signals;
monitor the sensor signals received from the sensor device to determine if one or more rules stored in memory are satisfied; and
in the event that one or more of the rules are satisfied, communicate with one or more devices to request assistance for the person.

52. The monitoring device according to claim 51, wherein the data received from the sensor device is indicative of motion of the person in the area, wherein the one or more rules monitored by the processing system use a presence or lack of motion sensed to determine if the person requires assistance.

53. The monitoring device according to claim 51, wherein the data received from the sensor device is indicative of one or more distances to the person relative to the sensor device, wherein the one or more rules monitored by the processing system use the one or more distances sensed to determine if the person requires assistance.

54. The monitoring device according to claim 53, wherein the one or more rules use a change in distances sensed over time to determine if the person requires assistance.

55. The monitoring device according to claim 51, wherein the monitoring device includes a communication device to wirelessly communicate with the sensor device.

56. The monitoring device according to claim 55, wherein the monitoring device determines, based on RSSI (received signal strength indicator), a communication frequency for use in wireless communication with the sensor device, wherein the determined communication frequency is transferred to the sensor device for use in wireless communication between the monitoring device and the sensor device.

57. The monitoring device according to claim 51, wherein the sensor device includes a thermal sensor, wherein the data received by from the sensor device is indicative of one or more signals generated by the thermal sensor, wherein the monitoring device uses the one or more signals generated by the thermal sensor to determine if the person requires assistance.

58. The monitoring device according to claim 51, wherein one or more rules monitored by the monitoring device are configurable.

59. The monitoring device according to claim 58, wherein the monitoring device receives configuration data from a server processing system to configure the one or more rules.

60. The monitoring device according to claim 58, wherein the monitoring device is in communication with a plurality of sensor devices mounted in the area, wherein the one or more rules are configured to use a distance defined between at least some of the plurality of sensor devices to determine if assistance is required for the person.

61. The monitoring device according to claim 51, wherein the monitoring device determines:
if the person has fallen;
if the person is incapacitated for a period of time;
if the person is suffering from impairment; and
if there is an increased risk of harm for the person.

62-66. (canceled)
